(19) United States
(12) Patent Application Publication
(10) Pub. No.: US 2026/0092181 A1
(43) Pub. Date: Apr. 2, 2026

(54) SELF-HEALING PRIMER WITH BLOCKED COMPOUNDS HAVING PROTECTED AMINE SUBSTIUENTS

(71) Applicant: SWIMC LLC, Cleveland, OH (US)

(72) Inventors: Liang LIANG, Twinsburg, OH (US); Dan ROHRER, Broadview Heights, OH (US)

(21) Appl. No.: 19/331,699

(22) Filed: Sep. 17, 2025

Related U.S. Application Data
(60) Provisional application No. 63/700,214, filed on Sep. 27, 2024.

(51) Int. Cl. C09D 5/00; C09D 7/20; C09D 7/80; C09D 133/08; C09D 163/00; C09D 175/04; C09D 183/04

(52) U.S. Cl. CPC C09D 5/002; C09D 7/20; C09D 7/80; C09D 133/08; C09D 163/00; C09D 175/04; C09D 183/04

(57) ABSTRACT

A coating composition is provided. The composition includes a coating polymer and a solvent. The coating polymer has units formed from one or more monomers. A plurality of the units have one or more functional groups reactive with amines. The coating polymer also has units formed from a self-healing compound containing a protected amine substituent, which when unprotected will react with the one or more functional groups in the coating polymer.

### CROSS REFERENCE TO RELATED APPLICATIONS

The present application is related to, and claims priority to, U.S. Provisional Application Ser. No. 63/700,214, filed Sep. 27, 2024, the contents of which are incorporated herein by reference in their entirety.

### TECHNICAL FIELD

The present invention relates to a self-healing primer composition that contains one or more functional groups reactive with amines and a blocked self-healing compound that provides unprotected amines when deblocked; coatings systems formed therefrom; and methods of making the same.

### BACKGROUND OF THE INVENTION

There is an increasing demand for the development and use of waterborne coatings due to environmental considerations, especially the negative impacts on environment resulting from solvent-borne coating solutions, and particularly the volatile organic compounds (VOC) associated therewith. Solvent borne primers are frequently used in the refinishing of vehicles, which provide improved performance in areas such as anticorrosion. However, the VOC associated with solvent-borne primers is one of the critical issues prompting interest in a switch to waterborne primers.

Low VOC and zero emission are significant advantages of waterborne coatings, providing a motivation to develop various waterborne coating solutions. Many efforts have been addressed to replace solvent-borne primers with waterborne primers. However, past efforts have resulted in poor performance, particularly in the area of anticorrosion, thus restricting the use of waterborne primers, especially for refinishing vehicles and for coating other metal surfaces in particular.

A primer is a paint or coating product that allows finishing paint to adhere to a surface much better than if it were used alone. It is designed to adhere to surfaces and to form a binding layer that is better prepared to receive the paint. Compared to paint, a primer is not typically intended to be used as the outermost durable finish and can instead be engineered to have improved filling and binding properties with the material underneath. Sometimes this can be achieved by chemistry, and others by controlling the primer's physical properties such as its porosity, tackiness, and hygroscopy. Some primers are further defined as etch primers, which may etch the surface to which it is applied to further promote adhesion between the etch primer and the surface.

### SUMMARY OF THE INVENTION

Accordingly, one object of the present invention is to provide hybrid primer compositions that have a combination of properties not otherwise attainable with a single polymer based waterborne primer.

A further object of the present invention is to provide “self-healing” primer composition coatings over a substrate, where the self-healing properties of the coatings mitigate corrosion to the substrate.

A further object of the present invention is to provide self-healing primer compositions that comprise blocked self-healing compounds with protected amines and that comprise functional groups reactive with amines such that if/when the self-healing compounds deblock, the protected amines become unprotected and react with the functional groups to self-heal the primer composition.

A further object of the invention is to provide self-healing primer compositions formed upon mixing a coating polymer with a blocked self-healing compound containing a protected amine substituent and a solvent. The coating polymer comprises units formed from one or more monomers. A plurality of the units have one or more functional groups reactive with an amine group. Upon deprotection of the protected amine substituent, the unprotected amine substituent on the blocked self-healing compound is reactive with the one or more functional groups of the coating polymer that are reactive with an amine group. Thus, the primer composition has self-healing properties when exposed to conditions that cause the deprotection of the protected amine substituent on the blocked self-healing compound. The self-healing primer composition can be waterborne and still provide comparable and/or improved anti-corrosion properties, among other properties, when compared to conventional solventborne primers.

A further object of the invention is to provide a coatings system over a substrate, particularly a metal substrate, comprising a self-healing primer layer applied over the substrate, a basecoat applied to the self-healing primer layer, and a clearcoat applied to the basecoat. The primer layer may be applied directly to the substrate without the use of a separate etch primer layer. The coatings system has a combination of properties not otherwise attainable with a conventional waterborne or solventborne coating systems.

Another object of the present invention is to provide a method for the production of self-healing primer compositions of the present invention, and methods for its use.

These and other objects of this invention, alone or in combination, have been satisfied by the discovery of a self-healing composition comprising a self-healing compound with a protected amine and amine-reactive functional groups. The self-healing primer composition and coatings systems made therefrom will be further described in the following detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a schematic of some embodiments of the formation of a crosslinked polymer network through a reaction between a deblocked silane and a functional group reactive with amines as further described herein.

FIG. 2 illustrates a schematic of imine-enamine tautomerization of silane compounds as used in some embodiments of the “self-healing” coating polymer described herein.

FIG. 3 illustrates a schematic of some embodiments of a deblocked silane compound having a secondary amine that reacts with an epoxide group to form additional crosslinks in a polymer network to provide self-healing properties.

FIG. 4 illustrates a schematic of some embodiments of a deblocked silane compound having a tertiary amine that can function as catalyst to react with an epoxide group to form additional crosslinks in a polymer network to provide self-healing properties.

FIG. 5 illustrates a schematic of some embodiments of a blocked silane that crosslinks with other silane compounds through hydrolysis and condensation reactions to form additional crosslinks in a polymer network.

FIG. 6 illustrates a schematic of some embodiments of a silane compound containing —OH groups that react with a substrate.

FIG. 7 illustrates a schematic of some embodiments of the formation of crosslinked polysiloxane via condensation of silane compounds comprising amines and —OH groups.

FIG. 8 illustrates a schematic of some embodiments of a hybrid epoxy-polysiloxane formed from a reaction between silane and epoxy resin.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “comprises” and variations thereof do not have a limiting meaning where these terms appear in the description and claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl.” For example, (meth)acrylic acid refers to both methacrylic acid and acrylic acid, and methyl (meth)acrylate refers to both methyl methacrylate and methyl acrylate.

The term “aliphatic” when used in the context of a carbon-carbon double bond includes both linear (or open chain) aliphatic carbon-carbon double bonds and cycloaliphatic carbon-carbon double bonds but excludes aromatic carbon-carbon double bonds of aromatic rings.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, water soluble oligomers and polymers, and the like.

The term “(co)polymer” as used herein includes both homopolymers (polymers containing units from a single monomer) and copolymers (polymers containing units from two or more different monomers), unless otherwise specifically stated. Copolymers also include star, dendritic, block, and grafting polymer.

The term “crosslinker” or “crosslinking component” as used herein refers to at least one molecule capable of forming a covalent linkage between polymers or between two different regions of the same polymer.

The term “on,” when used in the context of a coating applied on a substrate, includes both coatings applied directly or indirectly to the substrate. Thus, for example, a coating applied to a primer layer overlying a substrate constitutes a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

Within the context of the present invention, the term “hybrid primer” includes, but is not limited to, semi- and fully interpenetrating crosslinked networks of two polymer types, blends of two different polymer types that have been chemically bonded either directly or via a linking agent, chemically bonded crosslinked networks of two polymer types, a crosslinked network of one polymer type chemically modified by a compound that then can form its own crosslinked network after bonding to the original crosslinked network, and the like. Crosslinked networks can also be developed by thermal activation, redox reactions, gamma irradiation, and/or UV-irradiation.

Within the context of the present invention, the term “waterborne” is intended to mean that the polymeric components are in an aqueous medium. In certain embodiments, waterborne coatings provide one or more of the following advantages when compared to solventborne coatings: low toxicity and non-flammability due to low VOC levels and low HAP emissions; lower cost than solvent-borne coatings and no additives, thinners, or hardeners are required in most cases; less coating is required to cover the same surface area as compared to the use of solvent borne coating solutions; lower odor levels during application; and paint guns can be readily cleaned with water or water-based solutions and do not require paint thinner, acetone, or methyl acetate (further environmentally friendly and user safety friendly). Thus, byproducts from cleaning processing equipment used to produce waterborne coatings are also more environmentally and user friendly compared to byproducts from solvent borne coatings.

Within the context of the present invention, the term “substantially unreactive with” is intended to mean that if any reactions did occur after mixing two or more polymers together, then the number of reactions between the polymers are so few and insignificant that the overall viscosity of the mixture remains below 120 Krebs units after being stored for 30 days at 40 degrees Celsius. This viscosity limit indicates that no gelling has occurred, and thus, the resin component is still usable for coating applications with consistent performance properties.

The present invention relates to the formulation of self-healing primer coatings, methods used to prepare the self-healing primer coatings, and their use as coatings on substrates. The self-healing primer coatings of the invention can be used alone as a direct-to-substrate (or in certain embodiments, direct-to-metal or “DTM”) primer or in combination with a surface treatment on the substrate to be coated such as a chemical surface treatment to render the surface of the substrate better able to receive and bond with the self-healing primer coatings of the invention.

In certain embodiments of the invention, the self-healing primer includes a coating composition comprising a coating polymer and solvent. The coating composition can be solventborne or waterborne but is preferably waterborne. As will be discussed further herein, as a waterborne system, the self-healing primer composition has substantial performance improvements when compared to conventional solventborne systems. The disclosed coating polymer includes self-healing blocked compounds containing a protected amine substituent that can deblock and expose an unprotected amine substituent. The self-healing blocked compounds deblock due to imine-enamine tautomerization. For example, the blocked compounds comprise silanes, aliphatic aldimines such as ethanimine, substituted pyridines, enaminones (e.g., compounds containing an enamine group adjacent to a carbonyl group), heterocyclic compounds such as nitrogen-containing heterocycles with an alpha hydrogen on the imine carbon, or some other compound capable of deblocking via imine-enamine tautomerization. The coating polymer further includes functional groups reactive with amines. When the coating polymer is exposed to some external “healing” condition(s) (e.g., moisture, change in pH) that causes the self-healing blocked compounds to deblock, the protected amine substituent becomes unprotected and reacts with the functional groups reactive with amines. This reaction between the unprotected amine and functional groups within the coating polymer can occur even after the coating composition has cured. The below discussion and examples relate to silane compounds containing amine substituents for case of discussion, but it will be appreciated that any of the above self-healing compounds having protected amine substituents may be used in a waterborne primer with functional groups reactive with amines to provide self-healing properties.

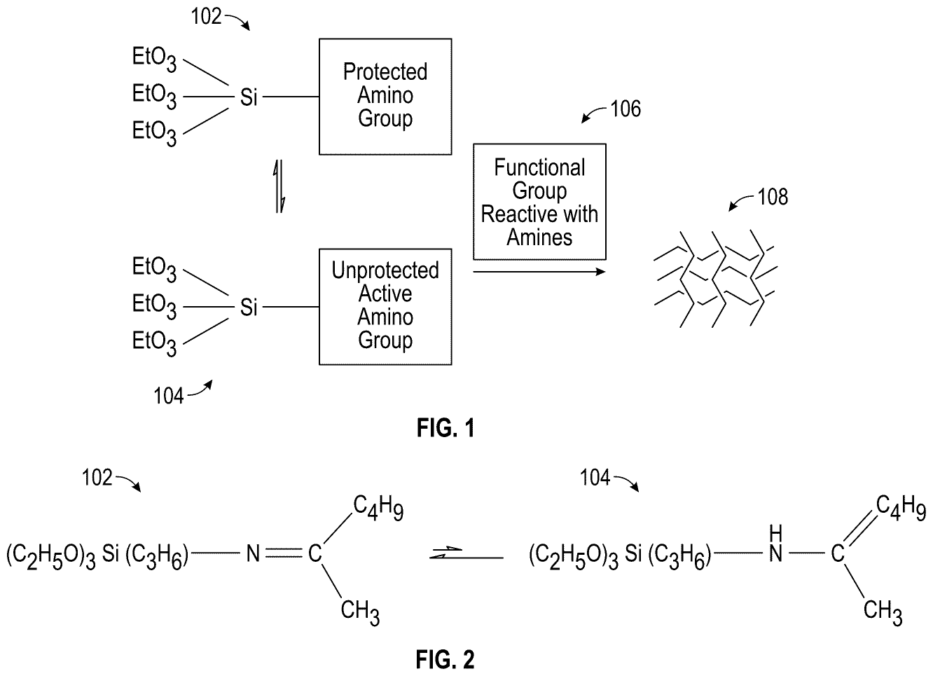

As an example, FIG. 1 illustrates a blocked silane 102 comprising a protected amino group that can deblock and form an unblocked silane 104 with unprotected active amino group when exposed to the external “healing” condition(s). Once deblocked, the unprotected active amino group of the deblocked silane 104 can react with an available functional group reactive with amines 106. Over time, as more blocked silanes 102 deblock and as more deblocked silanes 104 react with available functional groups 106, a crosslinked polymer network 108 is formed.

The coating composition may be applied to a substrate as a primer layer, in some embodiments. As a primer layer, the coating composition promotes adhesion between the substrate and any overlying layers (e.g., base coat, clear coat, etc.). The primer layer also serves as the last barrier between the substrate and the environment. Typically, a primer layer may be damaged during and/or after curing via external damage forces such as a mechanical force (e.g., scratch, chip), UV light, chemical exposure, and the like. For example, an automobile door may comprise a metal substrate covered by several coating layers, including the primer layer. An automobile door may get scratched throughout its lifetime. If the scratch extends into the primer layer, the substrate (or some other underlying layer) may be exposed. Since the exposed substrate is no longer protected by the primer layer, the exposed substrate would usually be at risk for corrosion. However, when the disclosed “self-healing” coating composition is used as the primer layer, the substrate's risk for corrosion is reduced when the primer layer is exposed to “healing” conditions (e.g., moisture, increased pH). Upon the self-healing primer layer's exposure to a basic and moist environment, the blocked silanes become deblocked such that unprotected amines react with available functional groups to generate crosslinking in the damaged primer layer. When used in an outdoor application, the self-healing primer layer may encounter a basic and moist environment via rain and snow. Additionally, if a consumer notices a scratch or other damage to the self-healing primer layer, the consumer may apply water to the self-healing primer layer at the area of the damage to promote the self-healing process.

By forming these new crosslinks at the area of damage, the primer layer will begin to “self-heal.” In some embodiments, the primer layer is fully restored by forming enough new crosslinks that the substrate (or an underlying layer) is no longer exposed. In other embodiments, the primer layer is partially restored by forming new crosslinks that strengthen the primer layer near the damaged area to mitigate further damage (e.g., peeling, chipping, etc.) to the primer layer but while leaving some of the substrate (or an underlying layer) still exposed. In yet some other embodiments, the primer layer is partially restored by covering the exposed portion of the substrate but having a reduced thickness when compared to other portions of the primer layer on the substrate. It will be appreciated that unless otherwise specified, the term “self-heal” or “self-healing” as used throughout this specification encompasses any of the aforementioned “fully restored” and “partially restored” conditions of the primer layer after exposure to external healing conditions.

FIGS. 2-5 illustrate a variety of crosslinking reactions that may occur between functional groups when a self-healing coating polymer comprising a blocked silane is exposed to a basic and moist environment. The silane compound containing a protected amine substituent may be a ketimine group containing compound or an aldimine group containing compound. For example, the silane compound that comprises protected amine substituents within the coating polymer may be 3-triethoxysilyl-N-(1, 3 dimethyl-butylidene) propylamine or N-(3-tricthoxysilylpropyl)benzaldehyde iminc. While the reactions in FIGS. 2-5 are based on silane compounds having a ketimine group containing compound, the blocked silane compound containing a protected amine substituent may include an aldimine group containing compound or other functional group with a protected amine substituent that may deblock under particular external conditions. Similarly, while the reactions in FIGS. 1-4 are include epoxide groups ready to react with the unprotected amine, the functional groups reactive with amines may also be, for example, isocyanates, n-succinimide-carboxylates, aldehydes, acid halides, and ketones.

FIG. 1 illustrates an example of imine-enamine tautomerization, which causes a blocked silane 102 with a protected amine substituent to deblock and form a deblocked silane 104 with an unprotected amine substituent when in the presence of moisture and a basic pH. In some embodiments, the primer composition comprising the coating polymer has a basic pH (greater than 7). For example, in some embodiments, the coating polymer comprises a disperser that is unstable in acidic conditions (pH less than 7). Acidity (or acid value) can be determined using conventional titration techniques, such as ASTM D4662 and ASTM D7253. Because the primer composition comprising the self-healing coating polymer is already basic, then exposing the self-healing coating polymer to a moist and more basic environment (i.e., more basic than the primer composition) can create sufficient polymer chain mobility in the basic coating to catalyze the imine-enamine tautomerization and expose unprotected amine substituents. In such a reaction, a proton is first removed from the base compound in the solution to form a resonance-stabilized carbanion. Then, the proton binds to the carbon or nitrogen in the imine to form an imine tautomer or an enamine tautomer. Imine tautomers (e.g., 102) are typically more favored in imine-enamine tautomerization over enamine tautomers (e.g., 104) except for when there are large alkyl groups on the nitrogen atom. Thus, to control the rate of deblocking and in turn, the self-healing properties of the coating polymer, the blocked silane containing an imine can become deblocked more quickly into an enamine (e.g., 104) in the presence of a higher pH if the groups on the nitrogen atom of the imine are enlarged based on imine-enamine tautomerization. It will be appreciated that if the primer composition comprising the self-healing coating polymer is already acidic, then exposing the self-healing coating polymer to a moist environment that is more acidic can also catalyze an imine-enamine tautomerization and expose unprotected amine substituents.

The rate of deblocking may depend on the application and/or the other reactive compounds within the primer composition. For example, after curing, the coating composition should still have blocked silanes available to allow the self-healing process to occur if needed; thus, the deblocking rate should not be too fast such that all silanes are deblocked during formulation of the composition. If the deblocking rate is too slow, however, the self-healing process may be so minimal during and after curing that the anti-corrosion properties are not improved. Additionally, as the silanes deblock, more crosslinks occur, which increases the viscosity of the composition. As the viscosity increases, polymer mobility decreases, less unprotected amine substituents come close enough to react with reactive functional groups to form additional crosslinks. This way, some unprotected amine substituents and/or blocked silanes remain available within the composition for future self-healing reactions. Thus, at least the number of silane compounds, the number of functional groups reactive with amines, and the size of the groups on the nitrogen atoms in the silane compounds can be tuned to achieve the desired self-healing rate. It has been found that protecting groups that show faster deblocking provide better self-healing properties than protecting groups that show slow-deblocking.

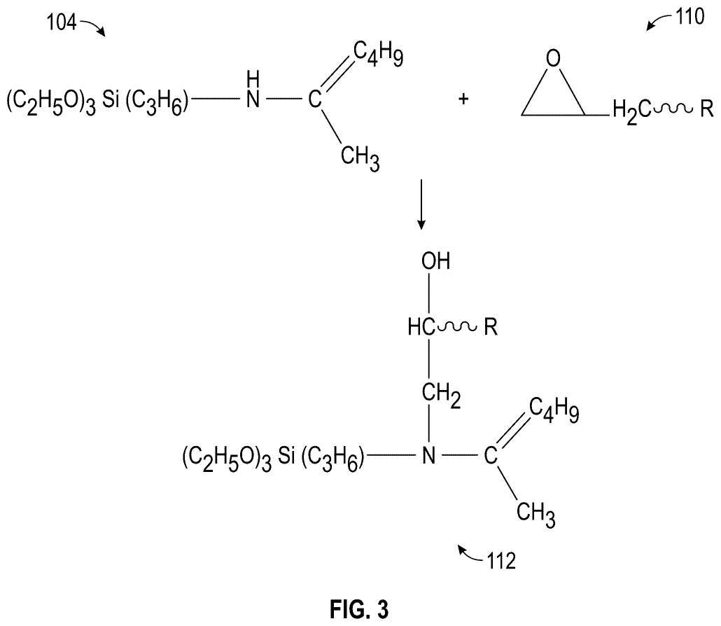

Turning additionally to FIG. 3, the deblocked silane 104 comprises a secondary amine. In some embodiments, the self-healing primer composition comprises an epoxy resin, which contains epoxide functional groups reactive with amines. Thus, as shown in FIG. 3, the secondary amine of the deblocked silane 104 may react with an epoxide group 110 of the epoxy resin via an opening-ring reaction to form amine-epoxy resin reaction product 112.

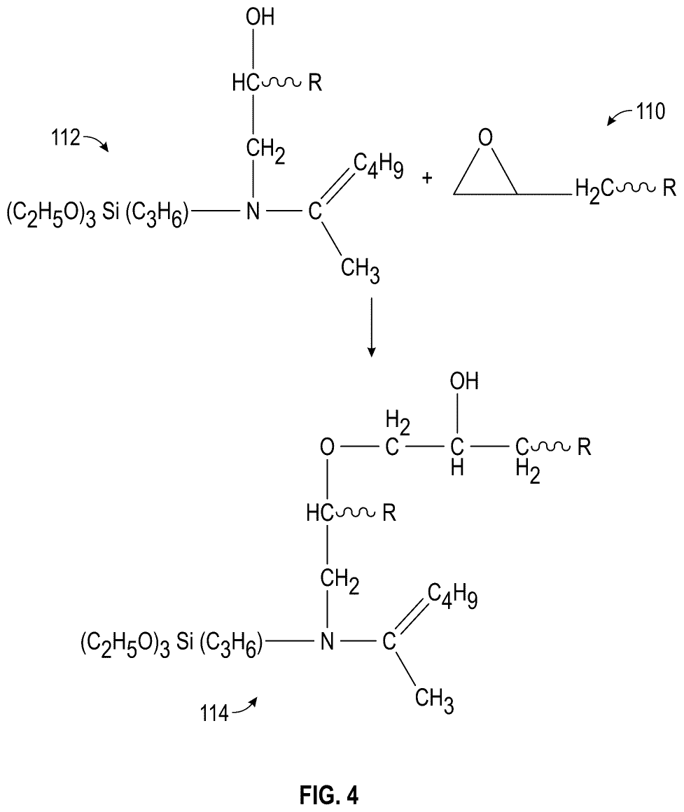

Turning additionally to FIG. 4, in some embodiments, the amine-epoxy resin reaction product 112 may react with yet another epoxide group 110 of the epoxy resin via an opening-ring reaction leading to crosslinked epoxy networks 114.

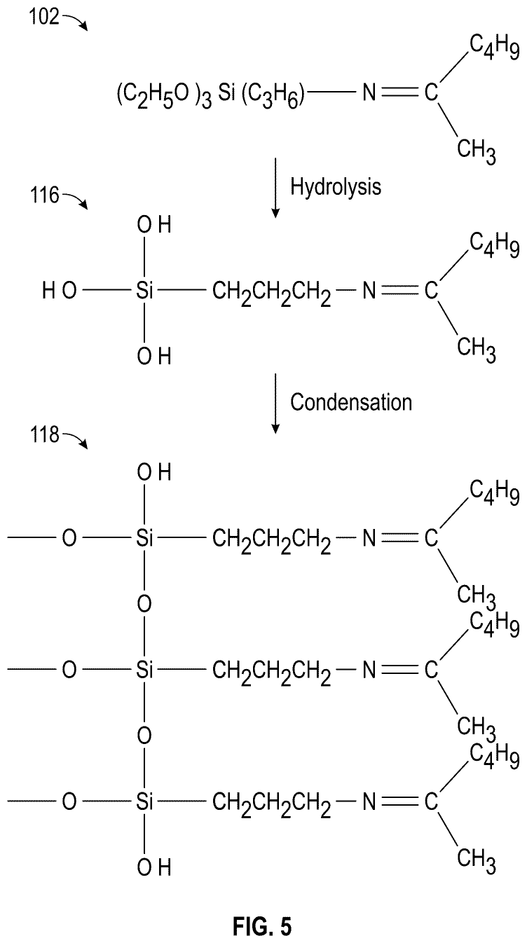

Turning additionally to FIG. 5, in some embodiments, even when the blocked silane 102 does not get deblocked, crosslinking may still occur in the presence of moisture due to a hydrolysis reaction. Through the hydrolysis reaction, a siloxane compound 116 is formed comprising hydroxyl groups. Then, through a condensation reaction, crosslinking between siloxane compounds occurs, thereby forming a polysiloxane network 118.

In some embodiments, the coating polymer is an epoxy resin, an acrylic resin, a urethane resin, siloxane resin, or hybrids of two or more thereof. The hybrid resins may be waterborne and include, for example, a hybrid epoxy-polysiloxane waterborne resin, a hybrid epoxy-polyurethane waterborne resin, a hybrid epoxy-polyacrylate waterborne resin, or a hybrid polyurethane-siloxane group containing waterborne resin. The self-healing coating polymer may be incorporated into a primer composition to improve the corrosion resistance of the coating composition. When incorporating the self-healing coating polymer into a primer composition, all of the blocked silanes could become deblocked, thereby leaving no blocked silanes remaining in the primer composition for future self-healing reactions. Therefore, as discussed above, the deblocking rate of the blocked silanes may be tuned to achieve a favorable balance of properties including shelf-stability, potlife, and self-healing by adjusting the size of the alkyl groups on the nitrogen atom. Additionally, the amount of blocked silanes in comparison to the amount of other functional groups in the primer composition can be tuned to ensure both blocked silanes and functional groups reactive with amines remain available after curing to retain its self-healing properties in the event that the cured primer composition is damaged.

As an example, when a primer composition is applied directly to a metal substrate, adhesive strength to the substrate is an important factor. In some such embodiments, the primer composition may be a hybrid epoxy-polysiloxane primer composition to achieve favorable properties of epoxy resins and polysiloxanes. The hybrid epoxy-polysiloxane primer composition comprises a hybrid epoxy-polysiloxane network having crosslinked epoxy resin regions and crosslinked polysiloxane resin regions. Optionally, the crosslinked epoxy resin regions and the crosslinked polysiloxane resin regions are crosslinked with one another to form interpenetrating polymer networks. Epoxy resins typically demonstrate good chemical and thermal stability, as well as good adhesive and mechanical strength. However, epoxy resins often exhibit a high rigidity property, which can reduce the flexibility of a coating formed therefrom, and sanding capability is also a challenge. Polysiloxane is a rubber type polymer having more hydrophobic and flexible properties compared with epoxy resins. Polysiloxane typically demonstrates good chemical, thermal, and weathering stability. Thus, the epoxy resin and polysiloxane can be combined to form a hybrid primer in order to provide the strength and stability benefits of the epoxy and the flexibility and hydrophobic properties of the polysiloxane in a single hybrid primer composition. The hydrophobic property of polysiloxane provides the capability to prevent penetration of water moisture through the film and the flexibility of polysiloxane chains to offer a softer more flexible property to the final film coated on a substrate, thereby improving overall flexibility of the film, the anti-degradation properties, and overall sanding capability. Further, by using a silane containing one or more amino or hydroxyl functional groups in providing the polysiloxane based portion of the hybrid primer, the hybrid epoxy-polysiloxane primer has enhanced adhesive strength with a substrate. Combined with the excellent chemical and thermal stability and mechanical strength of the epoxy resin, the resulting hybrid waterborne epoxy-polysiloxane primer exhibits much better performance compared with conventional solvent borne primers. The anti-corrosion properties of the primer composition can prolong the lifetime of the metal substrate. To further improve its anti-corrosion properties, a hybrid epoxy-polysiloxane primer composition may be modified to further include the disclosed blocked silanes with protected amine substituents as well as functional groups reactive with amines.

In some embodiments, the hybrid epoxy-polysiloxane primer composition is waterborne and formed from a two-component (“2K”) system. The 2K system comprises a first part and a second part. The first part comprises a waterborne epoxy resin which comprises functional groups reactive with amines, and the second part comprises a mixture of amines and silanes, including blocked silanes containing protected amine substituents. Some other silanes in the second part include silanes with available amino and/or hydroxyl groups. The blocked silanes can be added to the second part, especially when there are no functional groups reactive with amines in the second part. This way, even if some of the blocked silanes deblock, the resulting unprotected amine substituent does not have functional groups to react with, meaning the viscosity of the second part would not be substantially effected. In other words, the amines and silanes (blocked silanes and silanes with available amino and/or hydroxyl groups) in the second part are substantially unreactive with one another such that the second part is shelf-stable. Similarly, the waterborne epoxy resin is shelf-stable, indicating that compounds within the epoxy resin are substantially unreactive with one another. In some embodiments, the amine compounds comprise an aliphatic hybrid epoxy-amine compound. Upon mixing the first part with the second part, the crosslinked epoxy resin regions are formed at least from a reaction between the epoxy resin, the amines, and the silanes containing available amino and/or hydroxyl groups. In particular, curing (or crosslinking) of the epoxy resin is at least based on an opening-ring reaction when the epoxy resin is mixed with aliphatic amines. Additionally, the silane compounds containing available hydroxyl groups and/or amino groups can also react with the epoxy resin via an opening-ring reaction to form additional crosslinking. The blocked silanes may also interact with the epoxy-polysiloxane crosslinking reactions through similar reactions like those shown in FIGS. 2-5 and as further described herein.

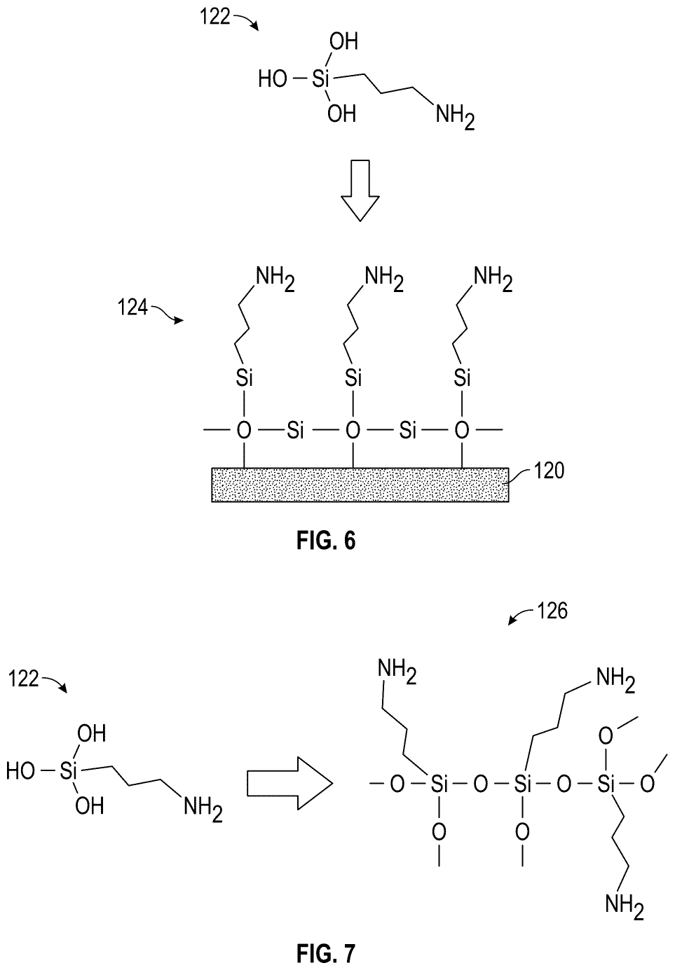

FIGS. 6-8 further explain the reactions that occurs when preparing some embodiments of the hybrid epoxy-polysiloxane waterborne primer and applying the hybrid epoxy-polysiloxane primer to a substrate.

FIG. 6 presents a magnified view of some embodiments of polysiloxane resin regions coupled to a substrate 120. In some embodiments, the substrate 120 comprises a metal, such as a cold roll steel, aluminum, or some other suitable metal. In some other embodiments, the substrate 120 comprises a plastic, a composite comprising plastic and metal, a glass, a ceramic, or some other material. At least when the substrate 120 comprises cold rolled steel and is exposed to silanes 122 comprising available hydroxyl and/or amino functional groups, the silanes 122 hydrolyze first and then condense with hydroxyl groups on the substrate 120 to form covalent bonds with the surface of the substrate 120. The silanes 122 may also bond to each other via condensation reactions. A grafted polymer structure 124 is formed on the substrate 120 to provide strong adhesion between the primer and the substrate 120. Additional functional groups (e.g., the NH₂ groups) may then be available for further reactions with the epoxy resin and other silicon based compounds.

FIG. 7 illustrates a schematic of some embodiments of yet another condensation reaction, where the silanes 122 containing available hydroxyl and/or amine functional groups react with another silicon based compound (not shown) to form a polysiloxane 126 and byproduct water.

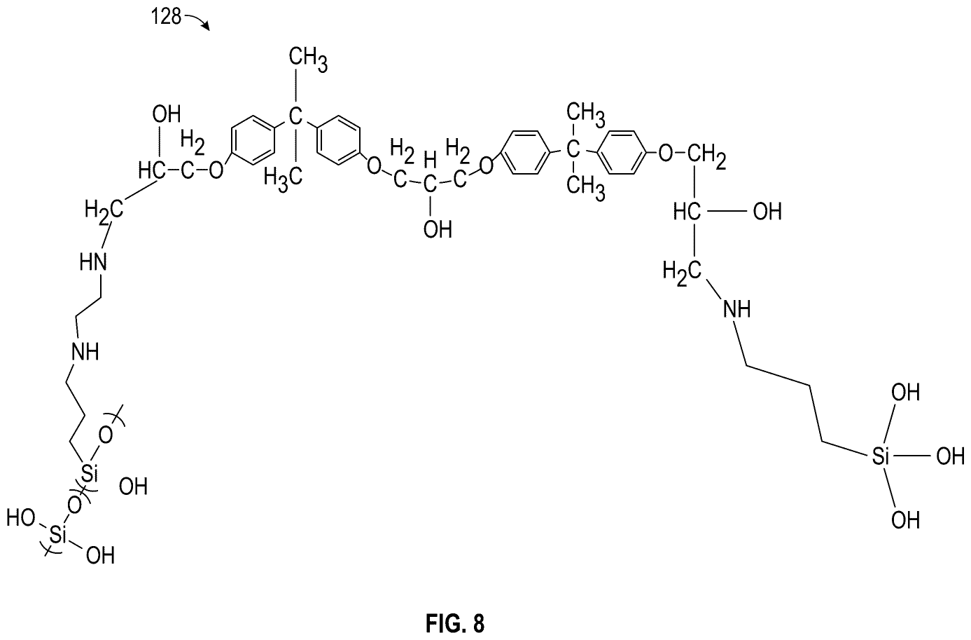

FIG. 8 presents a schematic of some embodiments of a product 128 formed by an epoxy resin and a silicon based compound. In some such embodiments, amino groups from a silicon based compound will also react with the epoxy resin to bind with the crosslinked epoxy resin. Further, when applied to a substrate having free hydroxyl groups, any hydroxyl groups from the silicon based compound can condense with hydroxyl groups on a surface of the substrate, which improves the adhesive strength of the hybrid epoxy-polysiloxane primer with the substrate.

Turning back to FIG. 5, the blocked silanes 102 may hydrolyze in the presence of moisture to form the siloxane compound 116, which comprises available hydroxyl groups. These hydroxyl groups on the siloxane compound 116 from FIG. 5 may react with the substrate 120 as shown in FIG. 6. Thus, the blocked silane 102 containing a protected amine substituent may contribute to the crosslinked network in the hybrid epoxy-polysiloxane primer composition, all while maintaining at least some of the protected amine substituents for future self-healing reactions in the event of damage to the resulting primer layer. It will be appreciated that some of the blocked silanes 102 may become deblocked when the blocked silanes 102 are initially mixed with the epoxy resin with high pH. As the blocked silanes 102 deblock, exposed amine compounds may react with available epoxy groups when initially mixed. The deblocking and subsequent reactions between an exposed amine and epoxy group will eventually slow down or stop because of the reversible reaction between blocked and deblocked silanes. Typically, the deblocking reaction is slow such that there are still enough blocked silanes 102 in the waterborne primer composition. For example, the primer composition may be formulated such that the rate of deblocking is not too fast such that all blocked silanes 102 deblock upon mixing; instead, the primer composition is formulated such that some blocked silanes 102 still exist even after curing for future self-healing reactions in the event of damage to the resulting primer layer. Additionally, while the migration of blocked silanes 102 decreases over time during formulation due to an increase in viscosity of the composition, when the resulting primer layer gets damaged, the blocked silanes 102 near the damaged site may have mobility due to the damage and thus, be available for self-healing reactions.

The coating composition may further comprise various additives to achieve desired properties for various applications. For example, in some embodiments, the coating composition may comprise hardeners to help facilitate curing at desired temperatures. Preferably, the primer composition is formulated to cure at room temperature. The various crosslinking reactions may also be accelerated by addition of small quantities of accelerators. Tertiary amines, carboxylic acids and alcohols (especially phenols) are effective accelerators for epoxy resins, for example. The accelerators and/or hardeners may be present in the first part or the second part of the 2K system (or additional parts of a system with more than two parts) given the first part or the second part remain shelf-stable with these additives. In some other embodiments, additional accelerators, hardeners, and other additives may be omitted from the 2K system.

The coating composition of the present invention may also include other optional ingredients that do not adversely affect the primer composition or a cured coating resulting therefrom, including the amount of blocked silanes retained for future self-healing reactions. Such optional ingredients include, for example, catalysts, dyes, pigments, toners, extenders, fillers, lubricants, anticorrosion agents, flow control agents, thixotropic agents, dispersing agents, antioxidants, adhesion promoters, light stabilizers, surfactants, defoam additives, leveling additives, rheology modifiers and mixtures thereof. Each optional ingredient is preferably included in a sufficient amount to serve its intended purpose, but not in such an amount to adversely affect the primer composition or cured coating resulting therefrom. For example, when the disclosed primer composition is formulated as a multi-component system, these optional ingredients preferably do not promote crosslinking within each component such that each part can remain self-stable and available for crosslinking upon mixing with the other parts.

The potlife of the coating composition can be measured by measuring the viscosity over time upon mixing the various parts of the composition. If the viscosity becomes too high (for example, greater than 120 Krebs units), then the composition may be too thick for application as a coating. Because the blocked silanes become deblocked, and thus contain reactive amines, in the presence of moisture and a higher pH, it is expected that the viscosity will increase if the blocked silanes are added to a mixture with an increased pH.

As an example, when a blocked silane comprising 3-triethoxysilyl-N-(1, 3 dimethyl-butylidene) propylamine is mixed into a water solution containing epoxy waterborne primer, the pH and viscosity of the mixture increase. In some embodiments, the viscosity increases from about 75 Krebs units to about 100 Krebs units within 80 minutes before stabilizing, and the pH increases from about 8.5 to about 10.8 within 30 minutes before stabilizing. After 120 minutes and a viscosity increase of over 30%, the solution may begin to stabilize. This large increase in viscosity can be attributed to the pH increase, which causes the blocked silanes to deblock and expose an unprotected amine substituent. This unprotected amine substituent can react with epoxide groups, thereby increasing crosslinking and increasing the viscosity. Thus, as the pH stabilizes, the deblocking and subsequent crosslinking reactions slow such that the viscosity may stabilize.

In another example, when a blocked silane comprising N-(3-triethoxysilylpropyl)benzaldehyde imine is mixed into a water solution containing epoxy waterborne primer, the pH and viscosity of the mixture stay almost unchanged over 90 minutes. Compared to the 3-triethoxysilyl-N-(1, 3 dimethyl-butylidene) propylamine compound in the prior example, the N-(3-triethoxysilylpropyl)benzaldehyde imine compound has smaller alkyl groups on the nitrogen compound and thus, has a slower deblocking rate. In some embodiments, the viscosity remained around 75 Krebs units over 90 minutes, and the pH stayed around 9 over 90 minutes. Because the N-(3-triethoxysilylpropyl)benzaldehyde imine compound has a slower deblocking rate, there are less unprotected amines available for reaction such that crosslinking reactions between unprotected amines and epoxide groups are minimal. Thus, blocked silane compounds with a slower deblocking rate may be selected over those with a higher deblocking rate if a lower viscosity and/or longer potlife is needed for a particular application. In some other embodiments, a combination of blocked silane compounds with a slower deblocking rate and blocked silane compounds with a faster deblocking rate may be selected to balance the viscosity and/or potlife needed for a particular application.

In some embodiments, the self-healing primer composition can be prepared by any desired method. As a non-limiting example, when the composition includes a hybrid epoxy-polysiloxane composition, a waterborne epoxy resin is first formed. The epoxy resin may comprise a latex epoxy dissolved in de-ionized water as a primary solvent and an organic solvent as a co-solvent. Because water is the primary solvent, meaning because there is more water than organic solvent, the overall epoxy resin is still considered waterborne. In one exemplary embodiment, the co-solvent may be dipropylene glycol dimethyl ether. In some embodiments, the epoxy resin further comprises various dispersants, deformers, pigments, anti-rust agents, anti-corrosion agents, fillers, leveling agents, epoxy latex, rheology modifiers, binders, and the like. Such additives in the self-healing primer composition may be hydrophilic, which advantageously absorb water moisture from the air; this can promote the self-healing process. For example, after the composition is applied as a self-healing primer layer on a substrate, if the layer becomes damaged, the hydrophilic properties in the self-healing primer layer attract moisture, which advantageously facilitates the deblocking of the self-healing compounds to promote self-healing at the damaged area.

The waterborne epoxy resin may then be mixed with an aliphatic amine, a first silicon based compound such as a silane oligomer with hydroxyl and amine groups, and a second silicone based compound such as a silane with amine and hydroxyl groups, wherein these aforementioned components are dissolved within a solution. The solution is stirred to dissolve the amine and silanes, and then the solution is applied to a substrate to form a self-healing primer layer on the substrate. In some embodiments, the self-healing hybrid primer composition comprises epoxy resin in an amount of, preferably, about 10 wt. % to about 80 wt. %, more preferably about 15 wt. % to about 50 wt. %, or even more preferably about 20 wt. % to about 30 wt. %. Further, the equivalent weight ratio of epoxy to aliphatic amine group additives may be in a range of between, for example, about 1.0 and 20. The aliphatic amine group additives do not include the protected amine substituents in the blocked silanes. In some embodiments, the self-healing hybrid primer composition comprises blocked silane in an amount of, preferably, about 1 wt. % and about 15 wt. % or more preferably about 5 wt. % and about 10 wt. %. In some embodiments, the self-healing hybrid primer composition comprises more than one type of blocked silane compound to achieve a desired self-healing effect.

Other non-limiting examples of suitable organic solvents for use in the primarily waterborne coating compositions of the present invention include aliphatic hydrocarbons (e.g., mineral spirits, kerosene, VM&P NAPHTHA solvent, and the like); aromatic hydrocarbons (e.g., benzene, toluene, xylene, the SOLVENT NAPHTHA 100, 150, 200 products and the like); alcohols (e.g., ethanol, n-propanol, isopropanol, n-butanol, iso-butanol and the like); ketones (e.g., acetone, 2-butanone, cyclohexanone, methyl aryl ketones, ethyl aryl ketones, methyl isoamyl ketones, and the like); esters (e.g., ethyl acetate, butyl acetate and the like); glycols (e.g., butyl glycol); glycol ethers (e.g., ethylene glycol monomethyl ether, ethylene glycol monoethyl ether, ethylene glycol monobutyl ether, propylene glycol monomethyl ether, and the like); glycol ether esters (e.g., butyl glycol acetate, methoxypropyl acetate and the like); and mixtures thereof.

The following examples show the improved properties of a coatings system comprising the disclosed self-healing waterborne primer compositions as a primer layer. These examples illustrate the present invention and its advantages but should not be construed as limiting a scope of the invention.

The following data was collected by comparing a conventional solvent borne coatings system with a waterborne first coatings system and a waterborne second coatings system. Each of the coatings systems comprises at least one primer layer over a substrate; a basecoat over the at least one primer layer; and a clearcoat over the basecoat. The composition of the etch primer layer and/or the primer layer vary amongst coatings systems as presented in TABLE 1.

TABLE 1

| Generic Layer | CONVENTIONAL | FIRST COATINGS | SECOND COATINGS |
|---|---|---|---|
| Type | COATINGS SYSTEM | SYSTEM | SYSTEM |
| CLEARCOAT | Conventional Solvent | Conventional Solvent | Conventional Solvent |
| | borne Clearcoat | borne Clearcoat | borne Clearcoat |
| BASECOAT | Conventional | Conventional | Conventional |
| | Waterborne Black | Waterborne Black | Waterborne Black |
| | Basecoat | Basecoat | Basecoat |
| PRIMER | Solvent borne | Waterborne Self- | Waterborne Self- |
| | Polyurethane | healing Hybrid Epoxy- | healing Hybrid Epoxy- |
| | | Polysiloxane Primer | Polysiloxane Primer |
| | | with “Slow” | with “Fast” |
| | | Deblocking Silanes | Deblocking Silanes |
| ETCH | Solvent borne Etch | NONE | NONE |
| PRIMER | Primer | | |
| SUBSTRATE | Cold Rolled Steel | Cold Rolled Steel | Cold Rolled Steel |

Thus, as shown in TABLE 1, the conventional coatings system comprises a conventional solvent borne etch primer layer over a cold roll steel substrate; a conventional solvent borne polyurethane over the conventional solvent borne etch primer layer; a waterborne conventional black basecoat layer over the conventional solvent borne polyurethane primer layer; and a conventional clearcoat layer over the conventional black basecoat layer. As shown in TABLE 1, the first coatings system comprises a waterborne self-healing hybrid epoxy-polysiloxane primer layer over the cold roll steel substrate; a conventional black basecoat layer over the waterborne self-healing hybrid epoxy-polysiloxane primer layer; and a conventional clearcoat layer over the conventional black basecoat layer. As shown in TABLE 1, the second coatings system comprises a waterborne self-healing hybrid epoxy-polysiloxane primer layer over the cold roll steel substrate; a conventional black basecoat layer over the waterborne self-healing hybrid epoxy-polysiloxane primer layer; and a conventional clearcoat layer over the conventional black basecoat layer. The self-healing primer layer of the first coating system comprises blocked silanes that deblock slower than the blocked silanes present in the self-healing primer layer of the second coatings system. For example, here, the blocked silanes in the self-healing primer layer of the first coatings system comprise N-(3-triethoxysilylpropyl)benzaldehyde imine, while the blocked silanes in the self-healing primer layer of the second coatings system comprise 3-triethoxysilyl-N-(1, 3 dimethyl-butylidene) propylamine. To eliminate the amount of available functional groups and blocked silanes as a variable, each self-healing primer layer of the first and second coatings system had the same ratio of epoxy to active amine group additives (around 1.25) and the same weight percent of blocked silane within the resin (around 5.5 wt %).

When the primer layer comprises the waterborne self-healing hybrid epoxy-polysiloxane primer composition, an etch primer can be omitted due to its excellent adhesion and anti-corrosion properties. In other embodiments, the self-healing coating polymer may be incorporated into a different resin system that benefits from an etch primer layer. Thus, in some other embodiments, an etch primer layer may be arranged between the substrate and the self-healing primer layer in a coatings system or another primer layer may be arranged between the self-healing primer layer and the basecoat.

For each of the first and second coatings system, the cold roll steel substrates were prepared by sanding and cleaning the steel substrate with a solvent; drying the steel substrate at room temperature; spraying the appropriate primer layer on the prepared substrate; drying the appropriate primer layer at room temperature overnight; sanding the appropriate primer layer; spraying a waterborne black basecoat layer to the appropriate primer layer; drying the waterborne black basecoat layer for one hour; and spraying a solvent borne clearcoat layer over the black basecoat layer.

For the conventional coatings system, the cold roll steel substrates were prepared by sanding and cleaning the steel substrate with a solvent; drying the steel substrate at room temperature; spraying the solvent borne etch primer on the prepared substrate; drying the solvent borne etch primer; spraying the solvent borne primer layer over the prepared substrate; drying the solvent borne primer layer; spraying a waterborne black basecoat layer to the appropriate primer layer; drying the waterborne black basecoat layer overnight; sanding the waterborne black basecoat layer; and spraying a solvent borne clearcoat layer to the black basecoat layer.

In the first and second coatings systems prepared for data collection, the dry film thickness of the self-healing primer layer was between 3.5 mil and about 4.5 mil. In the conventional coatings system prepared for data collection, the solvent borne etch primer layer had a dry film thickness from about 0.3 mil to about 0.4 mil, and a solvent borne primer layer had a dry film thickness from about 2.0 mil to about 2.5 mil. Thus, in the prepared samples, a sum of the dry film thicknesses of the etch primer layer and primer layer in the conventional coatings system was about 1.0 mil to about 1.5 mil less than the total dry film thickness of the self-healing primer layer in the first and second coatings systems. In each system, the waterborne basecoat had a dry film thickness of about 0.5 mil, and the clearcoat layer had a dry film thickness between about 3.0 mil and about 3.5 mil. It will be appreciated that other dry film thickness values may be used as long as ample drying time is allowed between coating of layers. While the first and second coatings systems prepared for data collection were slightly thicker than the conventional coatings system due to the thicker self-healing primer layer, the optical apparency, indicating a smooth surface, of the first and second coatings systems was comparable with that of the conventional coatings system.

In some embodiments, the chemical resistance of just the primer layer(s) arranged on the substrate of each coatings system can be tested by rubbing a paper soaked in methyl ethyl ketone (MEK) solvent on the substrate according to ASTM D5402-19. If the substrate is not exposed after 300 cycles of rubbing with MEK solvent, then the primer coating is considered to be “chemically resistant.” When the prepared samples were tested, the self-healing primer layer of the second coatings systems and the solvent borne etch primer layer and solvent borne primer layer of the conventional coatings system could withstand the at least 300 cycles and thus, are both sufficiently “chemically resistant.” In the self-healing primer layer of the first coatings system, the substrate was exposed after less than 200 cycles of rubbing with MEK solvent. Thus, in some embodiments, the slower the deblocking rate is on the blocked silanes, the weaker the chemical resistance is.

In some embodiments, the adhesive strength of the primer layer(s) of each coatings system can be evaluated using crosshatch testing according to ASTM D3359. This test evaluates adhesive strength by applying and removing pressure-sensitive tape over cuts made in the coating. The substrate and primer layer(s) are monitored to see if the primer layer(s) peel away from the substrate and/or stick to the tape. The primer layer(s) of each coatings systems had comparable adhesive results of 0%. The adhesive strength was also test on the entirety of each coatings system. The first and second coatings systems showed no peeling, while the conventional coatings system had peeling between the basecoat layer and the primer layer. Thus, the self-healing primer layers of the first and second systems had stronger adhesion to the overlying basecoat layer compared to the primer layers in the conventional coatings system.

In some embodiments, the impact resistance of each coatings system can be evaluated according to ASTM D5420. This test evaluates direct and non-direct impact strength of the coatings. Upon performing this impact resistance test, the first coatings system and the second coatings system had substantially the same results; each could withstand 160 psi impact directly and indirectly. The conventional coatings system had weaker results compared to the self-healing coatings systems; the conventional coatings system could only withstand about 100 psi directly and about 130 psi indirectly.

In some embodiments, the film flexibility of each coatings system can be evaluated according to a conical mandrel bend test disclosed in ASTM D522. Upon performing this flexibility test, each of the coatings systems received a passing score, meaning each coatings system exhibited a sufficient film flexibility for its intended applications.

In some embodiments, the optical appearance of each coatings system can be evaluated according to gloss retention at 20 degrees and/or distinctness of image (DOI) retention. Upon performing these optical appearance tests, each coatings system had similar gloss and DOI scores. Each of the coatings systems had gloss values between 88 and 90 and DOI scores between about 92 and 95.

In some embodiments, the dry time to a tack-free coating and the pot life was measured for each coatings system. Upon performing dry time and pot life tests, each coatings system had a comparable tack-free dry time (e.g., less than 15 minutes with air forced dry and greater than 45 minutes without air forced dry at room temperature) and a comparable pot life (e.g., greater than 60 minutes at room temperature).

To test the coating's behavior in a corrosive environment, each coatings system (with the basecoat and the clearcoat layers) may be placed in a salt fog chamber at an elevated temperature for a few weeks (e.g., about 30 degrees Celsius for about 20 days). Prior to loading the coated substrates into the salt fog chamber, a scratch is intentionally made into the primer layer and the etch primer layer (if present) of each coatings system. In some embodiments, the salt fog chamber testing is conducted in accordance with ASTM B117. After removing the coated substrates from the salt fog chamber, the amount of delamination and corrosion that occurred at the scratched part is evaluated upon cleaning the coated substrates with hot water and removing any film loss. The first self-healing coatings system and the conventional coatings system had comparable delamination and corrosion results, while the second self-healing coatings systems had significantly less delamination and corrosion when compared to the conventional coatings. For example, there was about a 60-75% reduction in delamination/corrosion size when the second coatings system was used compared to the conventional coatings system. Thus, the blocked silane with a faster deblocking rate provided the primer layer with more self-healing reactions than the blocked silane with a slower deblocking rate to mitigate corrosion and delamination in the salt fog chamber. This is because the blocked silane with faster deblocking rate provides more amine groups when exposed to moisture and a higher pH that can react with available epoxide groups in the primer layer to form new crosslinks and to prevent further damage to the second coatings system at the scratch.

The optical appearance and adhesive loss of each sample was again tested after being placed in a humidity chamber for 4 days. The optical appearance values were quantified by testing gloss retention at 20 degrees and DOI. Each sample was tested at room temperature before entering the humidity chamber; within one hour at room temperature after exiting the humidity chamber; and within 24 hours at room temperature after exiting the humidity chamber. Each coatings system had comparable gloss retention. The first and second coatings systems containing blocked silanes exhibited significantly better DOI results and adhesive loss. For example, after being exposed to room temperature for 24 hours to dry, the conventional coatings system had over double the amount of adhesive strength loss compared to the first and second coatings systems. Thus, the self-healing function of the first and second coatings systems was able to cure broken film when exposed to a high humidity environment while preventing further injury to the system.

It can be appreciated that other test methods may be used to evaluate the above properties as well as other properties of each coatings system set forth in Table 1. Additionally, the above comparisons between the properties of each coatings system are exemplary and may change depending on the exact formulation and/or application method of each layer in each coatings system.

As evidenced by the above exemplary data, in total, the first and second coatings systems containing blocked silanes for self-healing reactions performed substantially better compared to conventional coatings systems.

The following are non-limiting examples of some embodiments of the present invention:

Embodiment 1. A coating composition, comprising:
a coating polymer having units formed from one or more monomers, wherein a plurality of the units have one or more functional groups reactive with amines,
wherein the coating polymer further comprises units formed from a self-healing compound containing a protected amine substituent, which when unprotected will react with the one or more functional groups in the coating polymer, and
a solvent.

Embodiment 2. The coating composition of Embodiment 1, wherein the self-healing compound comprises at least one of a silane, an aliphatic aldimine, substituted pyridines, enaminones, or heterocyclic compounds.

Embodiment 3. The coating composition of Embodiment 1, wherein the self-healing compound comprises a nitrogen-containing heterocycle with an alpha hydrogen on the imine carbon.

Embodiment 4. The coating composition of Embodiment 1, wherein the self-healing compound is capable of deblocking via imine-enamine tautomerization.

Embodiment 5. The coating composition of Embodiment 1, wherein the self-healing compound comprises a silane.

Embodiment 6. The coating composition of Embodiment 5, wherein the self-healing compound containing a protected amine substituent is 3-triethoxysilyl-N-(1, 3 dimethyl-butylidene) propylamine or N-(3-triethoxysilylpropyl)benzaldehyde imine.

Embodiment 7. The coating composition of any one of Embodiments 1-6 wherein the one or more functional groups reactive with amines are selected from the group consisting of isocyanates, epoxy rings, n-succinimide-carboxylates, aldehydes, acid halides, and ketone.

Embodiment 8. The coating composition of any one of Embodiments 1-7, wherein the coating polymer has a pH greater than 7.

Embodiment 9. The coating composition of any one of Embodiments 1-8, wherein the protected amine substituent of the self-healing compound containing a protected amine substituent is a ketimine group containing compound or an aldimine group containing compound.

Embodiment 10. The coating composition of any one of Embodiments 1-9, wherein the coating polymer is a member selected from the group consisting of epoxy resins, acrylic resins, urethane resins, siloxane resins, and hybrids of two or more thereof.

Embodiment 11. The coating composition of any one of Embodiments 1-10, wherein the coating composition is a waterborne primer composition.

Embodiment 12. The coating composition of Embodiment 11, wherein the waterborne primer composition is a hybrid epoxy-polysiloxane waterborne primer, a hybrid epoxy-polyurethane waterborne primer, hybrid epoxy-polyacrylate or a hybrid polyurethane-siloxane group containing waterborne primer.

Embodiment 13. A self-healing coating formed from the coating composition of any one of Embodiments 1-12.

Embodiment 14. A method of preparing a coating composition, comprising:
combining a coating polymer comprising units formed from one or more monomers, wherein a plurality of the units have one or more functional groups reactive with an amine group, with a self-healing compound containing a protected amine substituent, and a solvent, to form a coating composition,
wherein upon deprotection of the protected amine substituent, the unprotected amine substituent on the self-healing compound is reactive with the one or more functional groups of the coating polymer reactive with an amine group, thus providing self-healing characteristics to the resulting coating composition.

Embodiment 15. The method of Embodiment 14, wherein the self-healing compound comprises at least one of a silane, an aliphatic aldimine, substituted pyridines, enaminones, or heterocyclic compounds.

Embodiment 16. The method of Embodiment 14, wherein the self-healing compound comprises a nitrogen-containing heterocycle with an alpha hydrogen on the imine carbon.

Embodiment 17. The method of Embodiment 14, wherein the self-healing compound is capable of deblocking via imine-enamine tautomerization.

Embodiment 18. The method of Embodiment 14, wherein the self-healing compound comprises a silane.

Embodiment 19. The method of Embodiment 18, wherein the self-healing compound containing a protected amine substituent is 3-triethoxysilyl-N-(1, 3 dimethyl-butylidene) propylamine or N-(3-triethoxysilylpropyl)benzaldehyde imine.

Embodiment 20. The method of any one of Embodiments 14-19, wherein the one or more functional groups reactive with amines are selected from the group consisting of isocyanates, epoxy rings, n-succinimide-carboxylates, aldehydes, acid halides, and ketone.

Embodiment 21. The method of any one of Embodiments 14-20, wherein the coating polymer has a pH greater than 7.

Embodiment 22. The method of any one of Embodiments 14-21, wherein the protected amine substituent of the self-healing compound containing a protected amine substituent is a ketimine group containing compound or an aldimine group containing compound.

Embodiment 23. The method of any one of Embodiments 14-22, wherein the coating polymer is a member selected from the group consisting of epoxy resins, acrylic resins, urethane resins, siloxane resins, and hybrids of two or more thereof.

Embodiment 24. The method of any one of Embodiments 14-23, wherein the coating composition is a waterborne primer composition and can be cured at room temperature.

Embodiment 25. The method of Embodiment 24, wherein the waterborne primer composition is a hybrid epoxy-polysiloxane waterborne primer, a hybrid epoxy-polyurethane waterborne primer, hybrid epoxy-polyacrylate, or a hybrid polyurethane-siloxane group containing waterborne primer.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several embodiments, such feature may be combined with one or more other features of the other embodiments as may be desired and advantageous for any given or particular application.

Additional modifications and variations of the present invention are possible in light of the above teachings. It is therefore to be understood that within the scope of the appended claims, the invention may be practiced otherwise than as specifically described herein.

What is claimed is:

1. A coating composition, comprising:
a coating polymer having units formed from one or more monomers, wherein a plurality of the units have one or more functional groups reactive with amines,
wherein the coating polymer further comprises units formed from a self-healing compound containing a protected amine substituent, which when unprotected will react with the one or more functional groups in the coating polymer, and
a solvent.

2. The coating composition of claim 1, wherein the self-healing compound comprises at least one of a silane, an aliphatic aldimine, substituted pyridines, enaminones, or heterocyclic compounds.

3. The coating composition of claim 1, wherein the self-healing compound comprises a nitrogen-containing heterocycle with an alpha hydrogen on the imine carbon.

4. The coating composition of claim 1, wherein the self-healing compound is capable of deblocking via imine-enamine tautomerization.

5. The coating composition of claim 1, wherein the self-healing compound comprises a silane.

6. The coating composition of claim 1, wherein the one or more functional groups reactive with amines are selected from the group consisting of isocyanates, epoxy rings, n-succinimide-carboxylates, aldehydes, acid halides, and ketone.

7. The coating composition of claim 1, wherein the coating polymer has a pH greater than 7.

8. The coating composition of claim 1, wherein the protected amine substituent of the self-healing compound containing a protected amine substituent is a ketimine group containing compound or an aldimine group containing compound.

9. The coating composition of claim 1, wherein the coating polymer is a member selected from the group consisting of epoxy resins, acrylic resins, urethane resins, siloxane resins, and hybrids of two or more thereof.

10. The coating composition of claim 1, wherein the coating composition is a waterborne primer composition.

11. A self-healing coating formed from the coating composition of claim 1.

12. A method of preparing a coating composition, comprising:
combining a coating polymer comprising units formed from one or more monomers, wherein a plurality of the units have one or more functional groups reactive with an amine group, with a self-healing compound containing a protected amine substituent, and a solvent, to form a coating composition,
wherein upon deprotection of the protected amine substituent, the unprotected amine substituent on the self-healing compound is reactive with the one or more functional groups of the coating polymer reactive with an amine group, thus providing self-healing characteristics to the resulting coating composition.

13. The method of claim 12, wherein the self-healing compound comprises at least one of a silane, an aliphatic aldimine, substituted pyridines, enaminones, or heterocyclic compounds.

14. The method of claim 12, wherein the self-healing compound comprises a nitrogen-containing heterocycle with an alpha hydrogen on the imine carbon.

15. The method of claim 12, wherein the self-healing compound is capable of deblocking via imine-enamine tautomerization.

16. The method of claim 12, wherein the self-healing compound comprises a silane.

17. The method of claim 12, wherein the one or more functional groups reactive with amines are selected from the group consisting of isocyanates, epoxy rings, n-succinimide-carboxylates, aldehydes, acid halides, and ketone.

18. The method of claim 12, wherein the coating polymer has a pH greater than 7.

19. The method of claim 12, wherein the protected amine substituent of the self-healing compound containing a protected amine substituent is a ketimine group containing compound or an aldimine group containing compound.

20. The method of claim 12, wherein the coating polymer is a member selected from the group consisting of epoxy resins, acrylic resins, urethane resins, siloxane resins, and hybrids of two or more thereof.

21. The method of claim 12, wherein the coating composition is a waterborne primer composition and can be cured at room temperature.
